(19) United States
(12) Patent Application Publication
(10) Pub. No.: US 2017/0232987 A1
(43) Pub. Date: Aug. 17, 2017

(54) Transport Cart

(71) Applicant: Helmut Abel, Maison-Laffitte (FR)

(72) Inventors: Helmut Abel, Maisons-Laffitte (FR); Diane Abel, Maisons-Laffitte (FR); Céline Abel, Maisons-Laffitte (FR)

(73) Assignee: Helmut Abel, Maison-Laffitte (FR)

(21) Appl. No.: 15/431,261

(22) Filed: Feb. 13, 2017

(30) Foreign Application Priority Data
Feb. 12, 2016 (DE) 10 2016 102 496.1

(51) Int. Cl. B62B 1/26; B62B 1/12; B62B 1/14

(52) U.S. Cl. CPC B62B 1/266; B62B 1/14; B62B 1/12; B62B 2202/26; B62B 2202/24

(57) ABSTRACT

A transport cart 40, which consists of a U-shaped bow, between the vertical struts of which horizontal struts in the form of round pipes are arranged one over another in levels. These transverse struts have multiple upwardly protruding holding elements, for example, in the form of inclined pins or journals, on which carrying bags are fastenable using the handles thereof.

### CROSS-REFERENCE TO RELATED APPLICATIONS

This application claims priority to German Patent Application No. 10 2016 102 496.1, filed Feb. 12, 2016, which is incorporated by reference in its entirety.

### BACKGROUND

The application relates to a two-wheeled, hand-guided transport cart having the structures and features recited herein.

### SUMMARY

A variety of such transport carts are sold commercially, specifically in the form of rigid transport carts, so-called luggage carts, and also in the form of folding transport carts. The latter are suitable in particular for private use, because in many embodiments the wheels, the cargo blade, and the bow, which is used as a pushing element, are collapsible, so that they can be stowed without problems in the trunk of a motor vehicle. Transport carts are also known, for example, from DE 20 2009 010 767 U1, the platform of which is provided with securing straps for fixing the transport goods.

The known transport carts are suitable for the transport of blocky or cubic transport goods, for example, filled crates, cardboard boxes, and the like, which are stackable. However, above all two-wheeled, hand-guided transport carts, on which commercially-available carrying bags filled with products can be fastened without problems using the carrying handles or carrying straps thereof and can be securely conveyed, are lacking.

These problems are also known from DE 20 2013 003 854 U1. To solve these problems, a specially designed carrying bag set for use in shopping carts is proposed in this publication.

However, a transport cart suitable for the transport of commercially-available carrying bags or pouches is lacking. Such dimensionally unstable carrying bags having handles are offered for sale in a large number, in various sizes, and consisting of greatly differing materials and are eagerly used by customers.

These flexible carrying bags are foldable and adapt themselves substantially to the filled transport goods by shape change.

However, it is problematic to convey such a carrying bag filled with cargo, in particular food, and in particular multiple carrying bags using a conventional two-wheeled transport cart. On the one hand, it is difficult to transport a carrying bag filled to the brim with cargo, which can be placed on the cargo blade of the transport cart, since the bag can fall off of the blade with even the slightest movement, because the bag contents are necessarily not stable in location and the thin-walled bag yields and deforms in all directions.

Such a variably-shaped bag may also only be fixed poorly using belts or straps, because the fastening means either slips off of the smooth and usually bulky bag or damages the frequently pressure-sensitive transport goods, for example, food.

It is still more difficult or even impossible to place a second fully filled carrying bag onto the first carrying bag located on the cargo blade. On the one hand, the second carrying bag does not have a solid hold on the first. On the other hand, it cannot be avoided that the transport goods located in the first carrying bag, for example, pressure-sensitive food, will be damaged.

The present application is thus based on the object of providing a two-wheeled, hand-guided transport cart of the type known from DE 197 13 33 U, using which carrying bags filled with products can be conveyed without difficulty and without the mentioned disadvantages.

The present application provides a transport cart having the features and structures disclosed herein.

Advantageous embodiments of the holding elements are further disclosed herein.

Advantageous refinement of the transport cart are also further disclosed herein.

A modification of the transport cart is further disclosed herein.

### BRIEF DESCRIPTION OF THE DRAWINGS

The subject matter of the present application is explained in detail hereafter on the basis of various exemplary embodiments. In the figures:

FIG. 1 shows a front view of a transport cart according to the present disclosure,

FIG. 2 shows a transport cart according to FIG. 1 in a side view, viewed in arrow direction A,

FIG. 3 shows an enlarged section of a holding element along line B-B in FIG. 1 according to a first exemplary embodiment,

FIG. 4 shows a section corresponding to FIG. 3 of a holding element according to a second exemplary embodiment,

FIG. 5 shows a side view of a loaded transport cart,

FIG. 6 shows a partial front view of a transport cart in the region of a transverse strut according to a second embodiment,

FIG. 7 shows an enlarged section along line D-D in FIG. 6 having tongue-shaped holding elements,

FIG. 8 shows a partial view of the transport cart according to FIG. 1 having suspended carrying bag,

FIG. 9 shows a front view of a transport cart according to the present disclosure according to a further exemplary embodiment,

FIG. 10 shows a partial front view of a transport cart in the region of two transverse struts according to a third exemplary embodiment,

FIG. 11 shows a partial front view of a transport cart according to a fourth exemplary embodiment,

FIG. 12 shows a front view of a transport cart according to a fifth exemplary embodiment, and

FIG. 13 shows an enlarged section along line E-E in FIG. 12.

### DETAILED DESCRIPTION

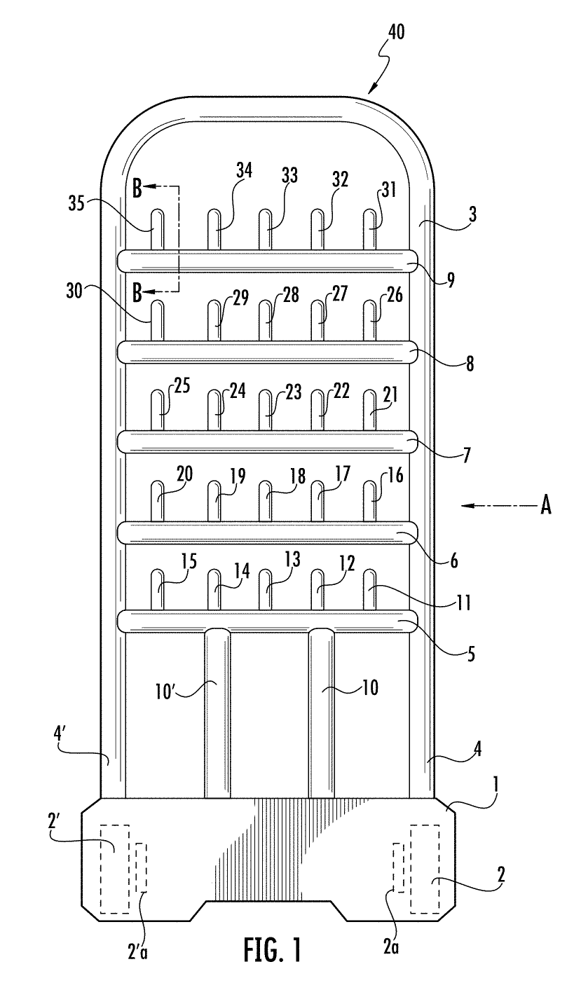

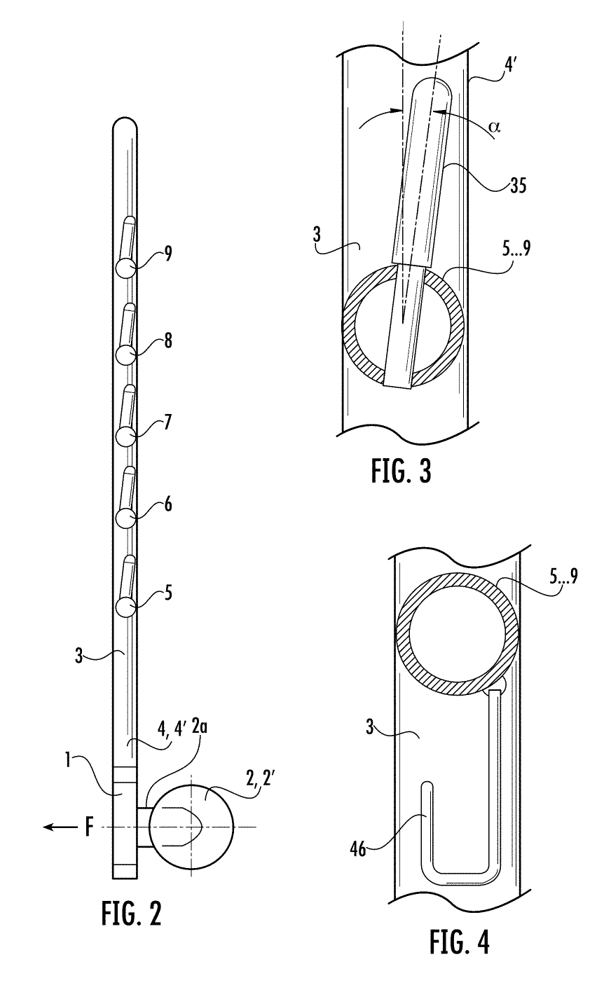

As FIGS. 1 and 2 show, the transport cart 40 according to the present disclosure comprises a U-shaped bow 3, which is used as a pushing element, and the legs 4, 4′ of which bow, which are designed as vertical struts, are connected at the bottom to a metal plate 1, on which bearing brackets 2a, 2′a for wheels 2, 2′ are attached at the rear in the travel direction F. The bearing brackets 2a, 2′a can be designed as collapsible into the plane of the bow for transport purposes.

Five horizontal transverse struts 5-9, which are designed as round pipes and are welded to the legs 4, 4′ of the bow 3, which are also designed as round pipes, are arranged in levels at approximately equal distances from one another between the legs 4, 4′ of the bow 3. The lower round pipe 5 is connected to the metal plate 1 via two round pipes 10, 10′, which are used for stiffening. Instead of round pipes, square pipes or solid profiles which are round or polygonal in cross section, for example, made of aluminum or hardwood, can also be used.

The round pipes 5-9 each carry five rounded, round-cylindrical metal pins adjacent to one another, i.e., a total of 25 equivalent pins which are used as holding elements as defined in the present disclosure. The metal pins, as illustrated in FIG. 3, are inclined to the rear by the angle α, which is preferably between 5-8°, in relation to the plane of the U-shaped bow 3.

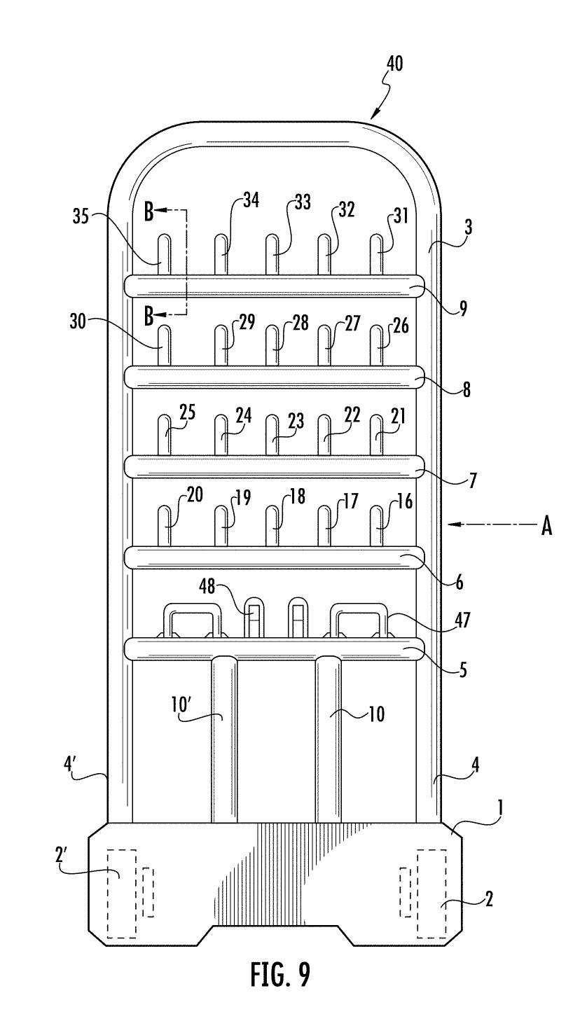

Instead of metal pins, inclined, closed bows 47, 48 or hooks 46 pointing downward can also be provided, as shown in FIGS. 9 and 4, respectively.

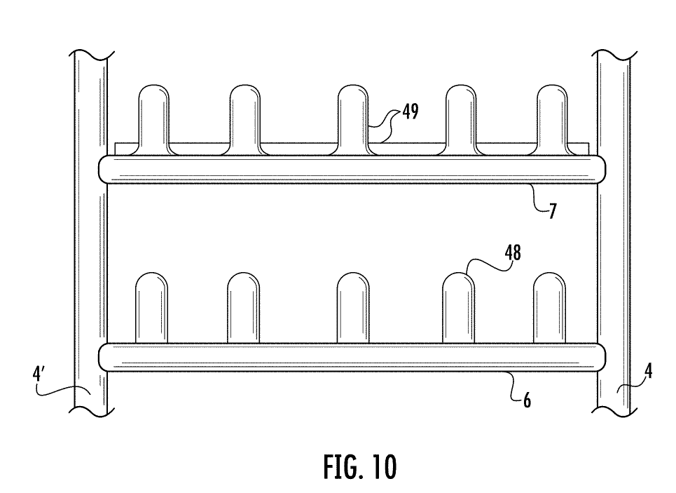

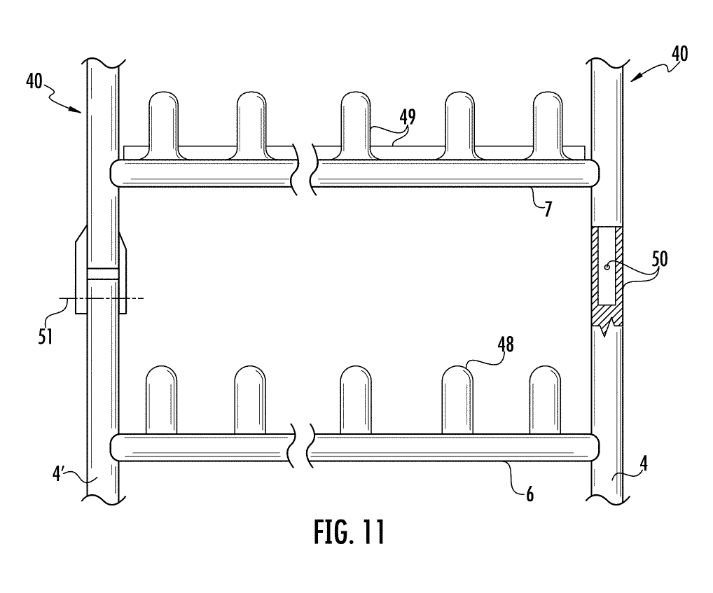

According to FIG. 10 or 11, the mentioned bows can also be connected to form a continuous strand 49, which is either attached to the transverse struts 7, for example, welded thereto, or arranged freestanding between the vertical struts 4, 4′ and fastened thereto.

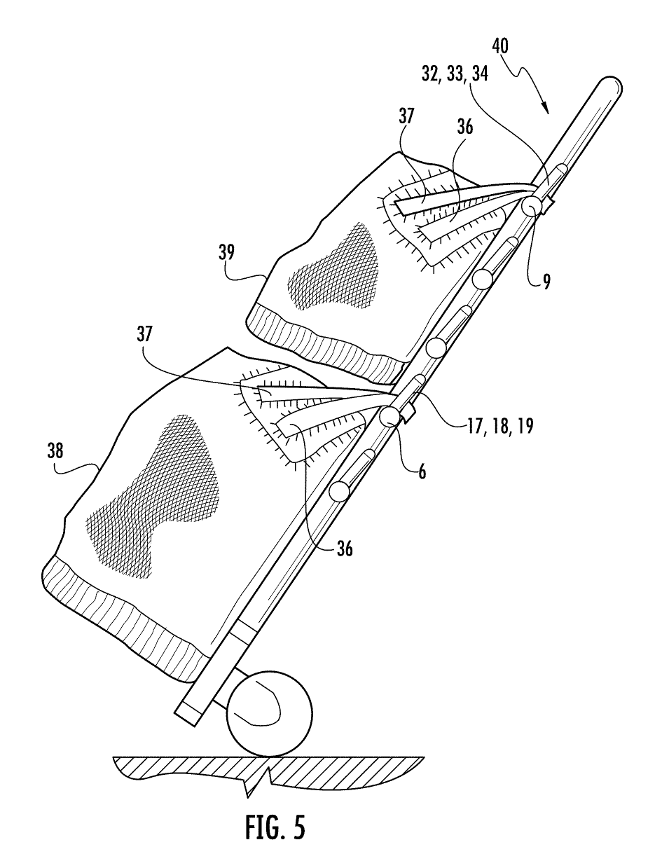

The use of the transport cart 40 according to the present disclosure is illustrated in FIG. 5. As shown therein, in this exemplary embodiment, two carrying bags 38 and 39, which are filled with transport goods, are suspended using the handles 36, 37 thereof in the metal pins 17, 18, 19 or 32, 33, 34, respectively, which are used as holding elements.

The loading of the transport cart is performed as follows.

The transport cart 40 is first pushed in the vertical position against the first carrying bag 38, which is standing on the floor. The user then pulls the closest handle 36 of the carrying bag as tautly as possible upward, to then slip it over the two pins 17 and 19, which are located at a greater distance. The second handle 37 is then pulled tautly upward, to also slip it over the pins 17 and 19.

If the carrying bag 38 is filled excessively full, it could be difficult to hang the handle 37 over the pins 17 and 19. In this case, the handle 37 can be suspended in the middle pin 18.

The large number of the pins 11-35 enables the use of differently designed carrying bags, the handle size and/or handle length of which can vary depending on the producer.

Because the pins 11-35 are inclined to the rear, the handles 36 and 37 also cannot slide off, so that the bags always remain connected to the cart.

Lateral swinging of the suspended carrying bags 38, 39 is prevented in that at least one of the two handles 36 is slipped over the pins 17 and 19 or 32 and 34, which are located at a greater distance, and therefore the carrying bags are laterally fixed.

After the first carrying bag 38 is suspended, the second carrying bag 39 can be suspended in a similar manner using the handles 36, 37 thereof in the pins 32, 33, 34 provided on the upper round pipe 9, so that it does not rest on the lower carrying bag 38, so that the transport goods packed therein are not crushed.

Another advantageous use of the transport cart according to the present disclosure is illustrated in FIG. 8.

An empty carrying bag 43 can accordingly be suspended on the transport cart 40 in a particularly simple manner. The one handle 44 of the carrying bag 43 can thus be suspended, for example, in the pins 11 and 15, which are located far apart from one another, so that the empty carrying bag 45 presses entirely against the front side of the transport cart 40 and cannot swing to the side. The second handle 45 is at least not yet suspended in this case, so that the carrying bag 43 remains bulging open.

The user can travel with a transport cart equipped, for example, with two open carrying bags to shop in a business, for example, a market hall, and can place products taken from the shelves into the still open bags. If the carrying bag 43 has been filled with products, the still free handle 45 is suspended either on the central pin 13 or the lateral pins 12 and 14.

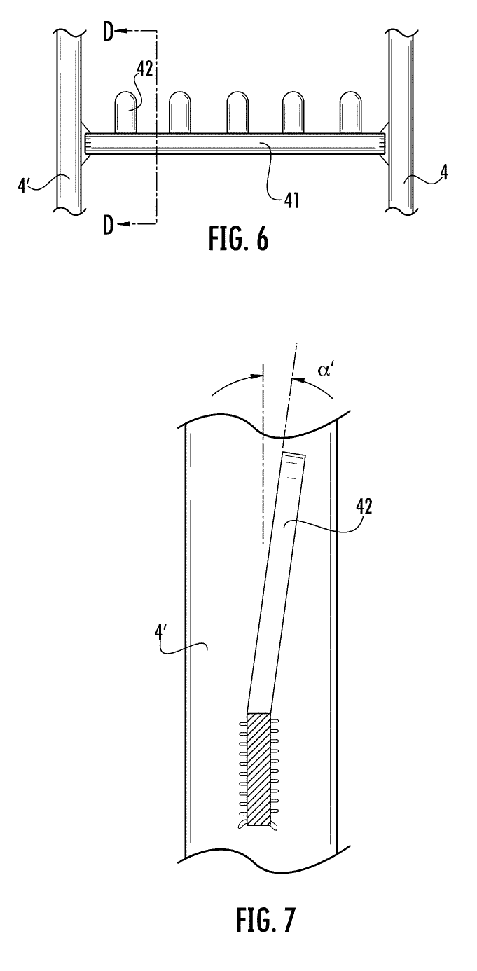

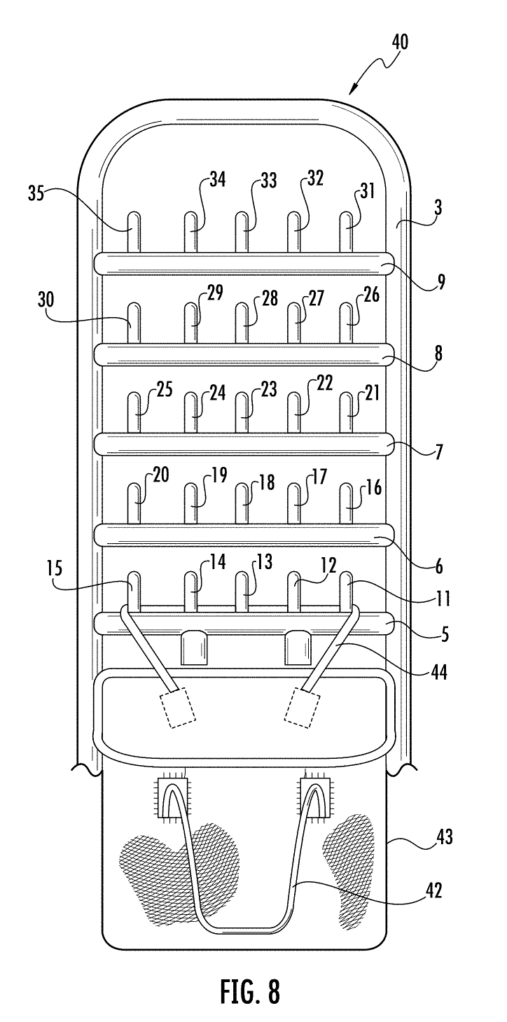

Finally, holding elements designed differently are shown in FIGS. 6 and 7.

Instead of the round pipes 5 to 9 having welded-on pins 11 to 35 pointing upward, plates 41 welded in between the vertical struts 4, 4′ can be provided as the horizontal transverse struts, which have one-piece tongues 42 instead of the metal pins. These tongues 42, as shown in FIG. 7, are also inclined by the angle α′ toward the rear of the transport cart 40.

Carrying bags can also be suspended by the handles thereof in this embodiment in the same manner as described on the basis of FIG. 5 or 8.

Since transport carts are frequently too bulky for conveyance in a passenger automobile, the legs 4, 4′ of the pushing element can be formed in two parts, as shown in FIG. 11.

In this case, the divided legs 4, 4′ either have a plug connection 50 or a joint 51, using which the leg parts can be divided or folded over for the purpose of transport.

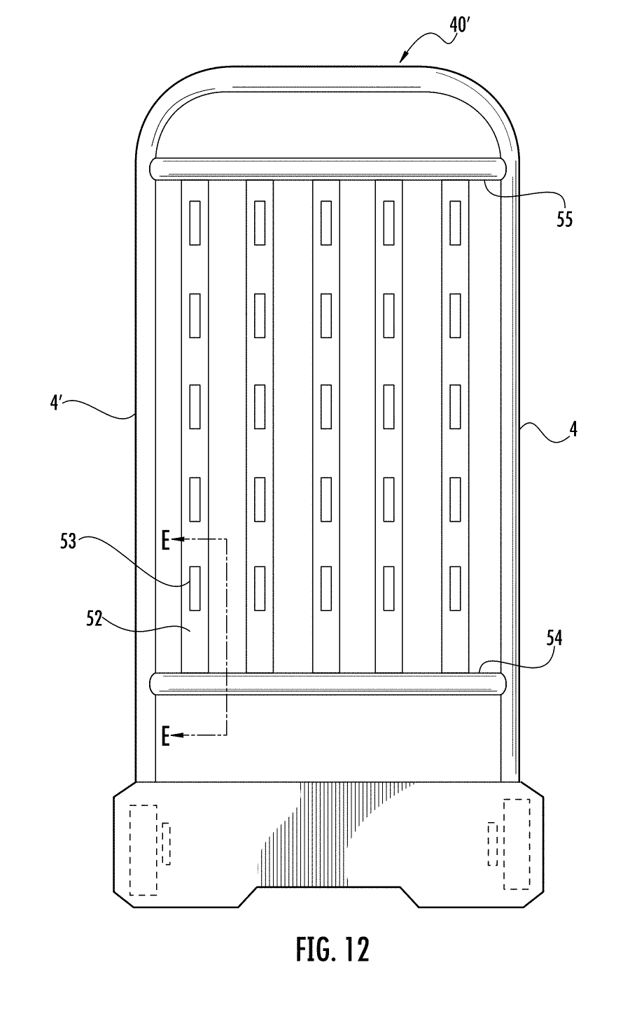

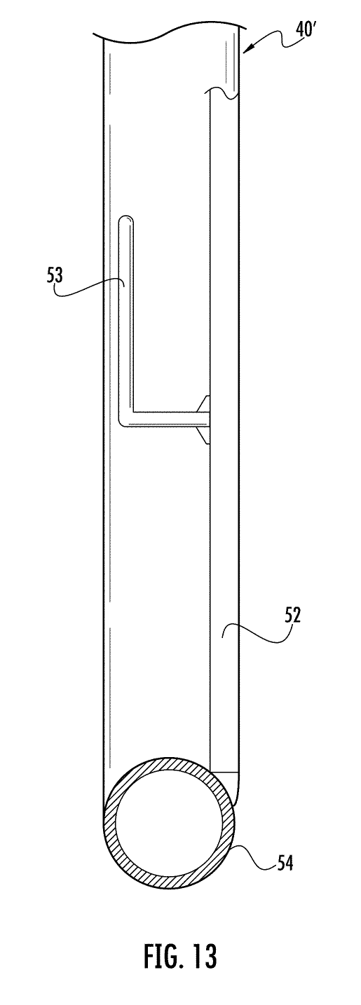

Finally, another variant of the transport cart 40′ is shown in FIGS. 12 and 13, in which, in a similar manner as in the transport cart according to FIG. 1, carrying bags of different sizes can be suspended at different heights. In this exemplary embodiment, the struts 52 having the holding elements 53 extend vertically and in parallel to the legs 4, 4′ of the U-shaped pushing element. The struts are connected at the ends to the transverse struts 54, 55 welded in between the legs 4, 4′.

As may be seen in FIG. 13, the holding elements may be designed here in the form of upwardly oriented hooks 53.

### LIST OF REFERENCE NUMERALS

1 slab
2, 2′ rollers
2a, 2′a bearing brackets
3 U-shaped bow as a pushing element
4, 4′ legs as vertical struts
5-9 round pipes as horizontal struts
10, 10′ vertical round pipes as connecting struts
11-35 metal pins as holding elements
36, 37 handle
44, 45 handle
38, 39 carrying bags
40, 40′ transport cart
41 plate
42 tongues
46 hook
47, 48 bow
49 integral strand having bows
50 plug connection
51 joint
52 longitudinal struts
53 hooks
54, 55 transverse struts

1. A hand-guided transport cart, comprising:
a pushing element having two parallel vertical struts;
an upper horizontal transverse strut connecting the two parallel vertical struts;
a roller rotatably mounted on an end of each of the two parallel vertical struts, wherein each roller is rotatably mounted opposite the upper horizontal transverse strut;
a plurality of transverse struts between the two parallel vertical struts, wherein the plurality of transverse struts are arranged in levels at a distance from one another between the two parallel vertical struts;
a plurality of holding elements located on each transverse struts of the plurality of transverse struts, wherein the plurality of holding elements protrude upward in relation to a ground, are provided adjacent to one another,
whereby carrying bags are fastenable to at least one of the holding elements of the plurality of holding elements using handles of the carrying bags.

2. The transport cart according to claim 1, wherein the plurality of holding elements are inclined pins or journals.

3. The transport cart according to claim 1, wherein the plurality of holding elements are hooks.

4. The transport cart according to claim 2, wherein the plurality of holding elements are inclined to a rear in relation to the pushing element by an angle between 5 and 8 degrees.

5. The transport cart according to claim 1, wherein each transverse strut of the plurality of transverse struts consists of plate, which has upwardly protruding tongues forming the plurality of holding elements.

6. The transport cart according to claim 1, wherein the plurality of holding elements are inclined, curved or U-shaped bows, which are closed on top and are fastened to a single transverse struts of the plurality of transverse struts.

7. The transport cart according to claim 6, wherein the U-shaped bows are part of a one-piece strand arranged between the vertical struts.

8. The transport cart according to claim 6, wherein the U-shaped bows comprise bent round or flat material.

9. The transport cart according to claim 1, wherein the pushing element is a U-shaped bow comprising round pipe with legs that are the two parallel vertical struts, wherein the end of each leg is connected via a plate, on which bearing brackets for the rollers are attached.

10. The transport cart according to claim 9, wherein the bearing brackets are collapsible into the plane of the pushing element.

11. The transport cart according to claim 9, wherein a rigid or collapsible cargo blade is provided on the plate.

12. The transport cart according to claim 9, wherein the legs of the pushing element comprises at least two parts, which are connected to one another via detachable plug connections or joints.

13. A hand-guided transport cart, comprising:
a pushing element having two parallel, vertical struts, which are connected to one another via at least two horizontal struts and on the ends of which close to a floor rollers are mounted so they are rotatable,
multiple longitudinal struts, which are arranged in parallel to the vertical struts of the pushing element, having upwardly open holding hooks are arranged adjacent to one another between the horizontal transverse struts.

14. A hand guided transport cart, comprising:
an U-shaped bow pushing element;
a pair of vertical strut legs depending from the U-shaped bow pushing element;
a plate connecting the pair of vertical strut legs at an end opposite the U-shaped bow pushing element;
a pair of wheels rotatably coupled to the plate;
a plurality of horizontal transverse struts connected to the vertical strut legs and located between the U-shaped bow pushing element and the plate;
a plurality of holding elements located on each horizontal transverse strut of the plurality of horizontal transverse struts; and
wherein each holding element of the plurality of holding elements projects from its respective horizontal transverse strut at an acute angle.

15. The hand guided transport cart, wherein the U-shaped bow pushing element has a side profile thickness, and the pair of vertical strut legs, the plate, the plurality of horizontal transverse struts and the plurality of holding elements do not extend beyond the side profile thickness of the U-shaped bow pushing element.

16. The hand guided transport cart, further comprising a stiffing rod connecting the plate and a lower horizontal transverse strut of the plurality of horizontal transverse struts.

17. The hand guided transport cart, further comprising a bow located on a lower horizontal transverse strut of the plurality of horizontal transverse struts.
